(19) United States
(12) Patent Application Publication
(10) Pub. No.: US 2006/0075698 A1
(43) Pub. Date: Apr. 13, 2006

(54) Luminous door for display units, in particular for refrigerators and refrigerators fitted with the said door

(76) Inventor: Cremaschi Alessandro, Pavia (IT)

Correspondence Address: NOTARO AND MICHALOS, 100 DUTCH HILL ROAD, SUITE 110, ORANGEBURG, NY, 10962-2100, US

(21) Appl. No.: 11/231,146

(22) Filed: Sep. 20, 2005

(30) Foreign Application Priority Data
Oct. 8, 2004 (IT) MI2004U 000455

(51) Int. Cl. E06B 3/26

(52) U.S. Cl. 52/202

(57) ABSTRACT

The invention proposes a door equipped with a wall consisting of a double-glazing unit made of transparent material, made in such a way as to be fitted on display units and in particular refrigerators, provided with LEDs a lighting system applied to the inside edge of the double-glazing unit gasket, fitted on a slanting support in such a way as to direct the light beam inside the display, thus allowing to avoid the use of complex and bulky lighting equipment currently in use, by a lighting system which operates at lower voltage and therefore under absolute safe conditions.

This invention proposes a door with its side consisting of a double-glazing unit made of transparent material, designed to be fitted on display units, in particular refrigerators of the kind used in bars and bakeries to preserve foodstuff, keeping them displayed to the public, which door includes, just close the inside edge of the double-glazing unit gasket, a LEDs lightning system, fitted on a slanting support, in such a way as to lead the light beam towards the products contained in the refrigerator.

As everybody knows, the display units and the food refrigerators installed in bars, restaurants or public places, require such an inside lighting as to allow a good visibility of the displayed products.

The said display units, which are generally equipped with a cooling equipment, are insulated on the five sides by thick and opaque walls, and the only side which allows to see inside consists of the opening door, which is provided with a door made of transparent material.

As a result of the foregoing, the natural light or the level of lighting of the environment in which the displays are placed are not generally sufficient to properly lighten the displayed products.

In order to remove the above-mentioned disadvantages, according to the prior art, refrigerators provided with lighting systems such as neon light or the like installed inside the refrigerator and able to offer a good lighting of the products are used.

The said known refrigerators have, on the other hand, several disadvantages, in particular because the lighting system implies some drawbacks such as the need to install inside the refrigerator, i.e. in the area accessible to the user, an electric equipment with consequent problems of insulation, protection, safety, compliance with the regulations and certification.

Beside that, the necessary areas for the lodging of the system itself and the lighting equipment must be provided, with the drawback that the area available for the display of the product must be reduced accordingly.

This invention falls into this sector, which invention proposes a door such as a double-glazing unit, equipped with a LEDs lighting system fitted into the hollow space of the said double-glazing unit, on at least one inside edge of the perimetral gasket, aiming at removing the said disadvantages.

Further advantages and features will be supplied, only by way of example but without any limitation thereto, by the following description and by the drawings annexed hereto, in which:

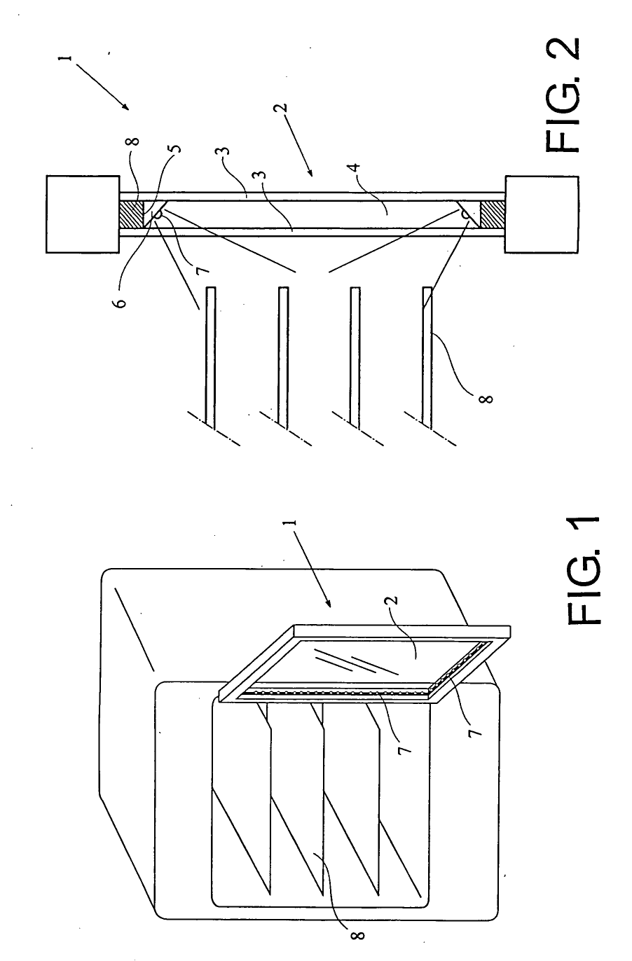

FIG. 1 is the view of a display unit/refrigerator lightened from the inside, with a door provided with transparent double-glazing unit according to this invention;

FIG. 2 is a sectional view of the door according to this invention.

With reference to the annexed figures, 1 shows, as a whole, the door of a refrigerated display unit, in which the transparent element consists of a double-glazing unit 2, of the kind composed of two or more sheets of glass or analogous transparent material 3, with a perimetral insulating layer 8 fitted thereinto, which borders, between the two sheets of glass, a double-glazing unit which can be filled up with inert gases in order to improve its insulating capacity.

On at least one inside edge 5 of the perimetral gasket 8 of the double-glazing unit 2, and therefore inside the double-glazing unit itself, a support 6 is fitted with a slanting surface on which a plurality of luminous LEDs is applied.

Since the surface of the support 6 is inward-slanting, the luminous flux emitted by the LEDs lightens the inside part of the refrigerator and the displayed products placed thereinto.

As a result of the foregoing, the product will be lightened both by the LEDs direct light and the indirect light reflected by the walls, so that it will be possible to clearly see both the products placed closer to the door, and those placed more inside, displayed towards the bottom.

The electric power, direct current at lower voltage, may be brought inside the double-glazing unit through cables which pass through the perimetral gasket between the two sheets of glass according to prior art in this sector.

By the use of a door according to this invention, it will be thus possible to lighten the content of the refrigerators without resorting to complex electric and lighting systems fitted in the area accessible to the public.

Since the LEDs are powered by current at lower voltage, generally ranging between 5 and 24 volts in direct current, also the general safety of the apparatus turns out to be improved, with considerable reduction of the risks of accidents due to malfunctions or failures or aging of the electric system.

Also the current consumptions will be drastically reduced, thanks to the minimum power absorption rate of the LEDs.

Also the complex certification procedures which guarantee the compliance with strict safety regulations may be avoided.

As it will be clear from the description above, a refrigerator equipped with a luminous door according to this invention turns out to be safer, less expensive as regards the electricity consumption and may, dimensions being equal, have a higher capacity, since all that space which was previously occupied by the neon lights, by the relevant power systems and by the insulation and protection system, will be available to display the products.

A skilled in the art may make changes and different versions which must be all considered included within the scope of this invention as defined by the appended claims.

1. Door of the kind equipped with a wall consisting of a double-glazing unit made for transparent material for display units, in particular for refrigerators, characterized in that it provides for a lighting system fitted inside the said double-glazing unit.

2. Door for display units and refrigerators according to claim 1, characterized in that the said lighting system consists of a plurality of LEDs fitted between the sheets of glass of the double-glazing unit.

3. Door for display units and refrigerators according to claim 2, characterized in that the said lighting system consists of a plurality of LEDs fitted along at least one side of the dobule-glazing unit.

4. Door for display units and refrigerators according to claim 3, characterized in that the said lighting system consists of a plurality of LEDs, fitted just close the inside edge of the perimetral gasket of the said dobule-glazing unit.

5. Door for display units and refrigerators according to claim 1, characterized in that the said LEDs lighting system is fitted on a support slanting towards the inside of the display unit, in such a way as to direct the light beam produced by the LEDs toward the products contained in the display.

6. Refrigerator characterized in that it provides for a door having a lighting system according to claim 1.
